(19) United States
(12) Patent Application Publication
(10) Pub. No.: US 2013/0308905 A1
(43) Pub. Date: Nov. 21, 2013

(54) OPTICAL FIBER AND LIGHT COUPLING SYSTEM USING SAME

(71) Applicant: I-THUN LIN, Tu-Cheng (TW)

(72) Inventor: I-THUN LIN, Tu-Cheng (TW)

(21) Appl. No.: 13/660,016

(22) Filed: Oct. 25, 2012

(30) Foreign Application Priority Data
May 15, 2012 (TW) 101117287

(51) Int. Cl. G02B 6/02; G02B 6/26

(52) U.S. Cl. 385/39; 385/123

(57) ABSTRACT

A light coupling system includes a laser light source and an optical fiber. The optical fiber includes a fiber core having a central optical axis, and a cladding layer surrounding the fiber core. The optical fiber has a distal end surface covering a distal end of the fiber core and a distal end of the cladding layer. The distal end surface includes an inner conical surface centered on the central optical axis, and an outer frustoconical surface centered on the central optical axis and surrounding and adjoining the inner conical surface. A cone angle of the inner conical surface is greater than a cone angle of the outer frustoconical surface. The distal end surface of the optical fiber faces toward the laser light source.

### BACKGROUND

1. Technical Field

The present disclosure relates to an optical fiber and a light coupling system using same.

2. Description of Related Art

In a typical light coupling system, in order to couple an optical fiber with a light source, a lens located at the end of the optical fiber converges light emitted from the light source to the optical fiber. However, this makes the system complicated.

What is needed, therefore, is an optical fiber and a light coupling system using same, which can overcome the above shortcomings.

### BRIEF DESCRIPTION OF THE DRAWINGS

Many aspects of the present optical fiber and light coupling system can be better understood with reference to the following drawings. The components in the drawings are not necessarily drawn to scale, the emphasis instead being placed upon clearly illustrating the principles of the present optical fiber and light coupling system. Moreover, in the drawings, like reference numerals designate corresponding parts throughout the several views.

FIG. 1 is a cross sectional view of an optical fiber in accordance with an embodiment.

FIG. 2 is a light coupling system using the optical fiber of FIG. 1.

### DETAILED DESCRIPTION

Embodiments of the present disclosure will now be described in detail below and with reference to the drawings.

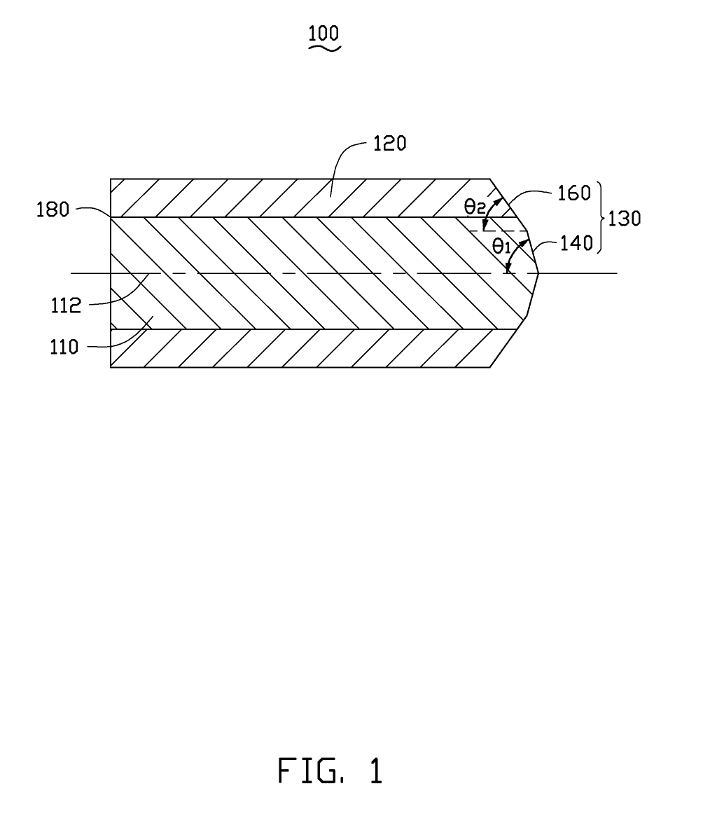

FIG. 1 illustrates an optical fiber 100 in accordance with an embodiment. The optical fiber 100 includes a fiber core 110 and a cladding layer 120 surrounding the fiber core 110. The optical fiber 100 has a distal end surface 130 for optically coupling to a light source.

The fiber core 110 is configured for transmitting light signal. The fiber core 110 has a central optical axis 112, and a diameter of the fiber core is in a range of 9-100 micrometers. The cladding layer 120 is in directly contact with the fiber core 110, and is configured for reflecting light signal to the fiber core 110. An outer diameter of the cladding layer 120 is in a range of 100-150 micrometers.

The coupling end surface 130 includes an inner conical surface 140 centered on the central optical axis 112, and an outer frustoconical surface 160 centered on the central optical axis 112 and surrounding and adjoining the inner conical surface 140. The inner conical surface 140 and the outer frustoconical surface 160 each protrude toward the central optical axis 112. A cone angle θ1 of the inner conical surface 140 relative to the central optical axis 112 is greater than a cone angle θ2 of the outer frustoconical surface 160 relative to the central optical axis 112. The inner conical surface 140 and the outer frustoconical surface 160 cooperatively cover an entire distal end of the fiber core 110 and an entire distal end of the cladding layer 120.

In the present embodiment, a diameter of the inner conical surface 140 is less than a diameter of the fiber core 110. The outer frustoconical surface 160 extends from a periphery of the inner conical surface 140 to an outer periphery of the cladding layer 120.

The cone angles θ₁ and θ₂ are less than 90 degrees. A detail number of the cone angles θ₁ and θ₂ can be varied the above range according to a size of a light source (or a size of an emitting window of a light source) and a distance between the coupling end surface 130 and the light source. Usually, the greater the size of the light source is, and the farther the distance between the coupling end surface 130 and the light source is, the smaller of the cone angles θ₁ and θ₂ is better. In contrast, the cone angles θ₁ and θ₂ can be enlarged.

The optical fiber 100 may have a metallic shell (not shown) surrounding the cladding layer 120 for protecting the fiber core 110 and the cladding layer 120. An opposite end surface 180 of the optical fiber 100 may be a planar surface.

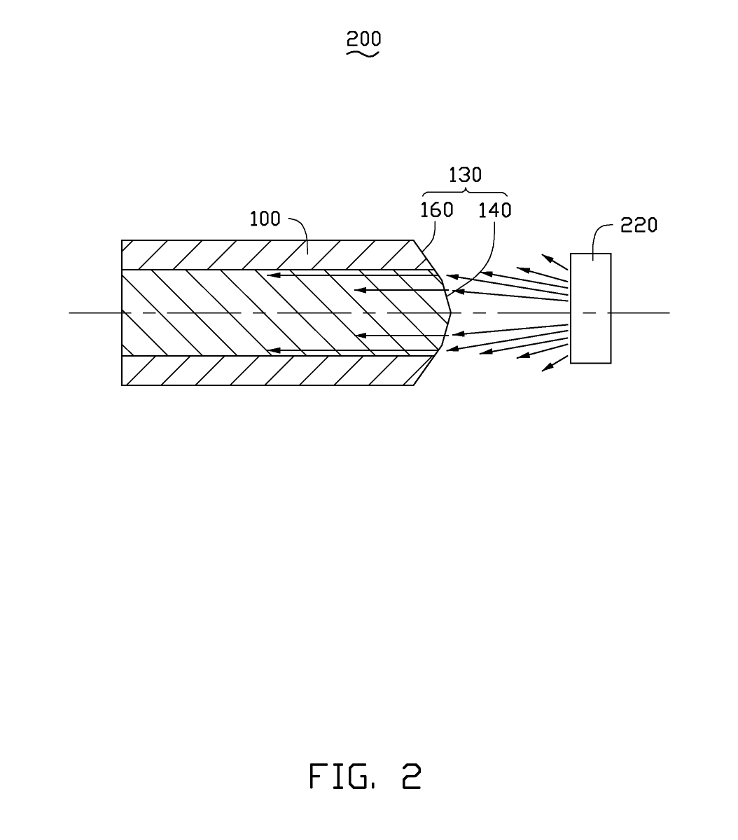

Referring also to FIG. 2, a light coupling system 200 using the optical fiber 100 is shown. The light coupling system 200 includes a laser light source 220 and one optical fiber 100. The coupling end surface 130 faces toward the laser light source 220.

The laser light source 220 emits light in a Gaussian distribution, i.e., light intensity is weaker, and light output angle is greater as away from an optical axis of the laser light source 220. The outer frustoconical surface 160 can refract light away from the optical axis of the laser light source 220 to the fiber core 110, thereby reducing light transmitting out of the cladding layer 120. The inner conical surface 140 can refract light closer to the optical axis of the laser light source 220 to be substantially parallel light with the central optical axis 112, such that it can reduce refraction of the light multiple times and reduce light reflection in the fiber core 110 and as well as in the cladding layer 120.

Concluded from the above, the above inner conical surface 140 and outer frustoconical surface 160 of the coupling end surface 130 can help refract light with different output angles to the fiber core 110, such that light transmitting out of the cladding layer 120 is reduced, and thereby light loss is reduced. As the light in greater output angle can be refracted to the fiber core 110, the coupling end surface 130 is especially in good to use for the laser light source 220 emitting light in such Gaussian distribution.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An optical fiber, comprising:
a fiber core having a central optical axis; and
a cladding layer surrounding the fiber core, wherein the optical fiber has a distal end surface covering a distal end of the fiber core and a distal end of the cladding layer, the distal end surface comprising an inner conical surface centered on the central optical axis, and an outer frustoconical surface centered on the central optical axis and surrounding and adjoining the inner conical surface, a cone angle of the inner conical surface being greater than a cone angle of the outer frustoconical surface.

2. The optical fiber of claim 1, wherein the outer frustoconical surface covers the distal end of the cladding layer and a peripheral portion of the distal end of the fiber core.

3. The optical fiber of claim 1, wherein the diameter of the fiber core is in a range of 9-100 micrometers.

4. A light coupling system, comprising:
a laser light source; and
an optical fiber comprising a fiber core having a central optical axis; and a cladding layer surrounding the fiber core, wherein the optical fiber has a distal end surface covering a distal end of the fiber core and a distal end of the cladding layer, the distal end surface comprising an inner conical surface centered on the central optical axis, and an outer frustoconical surface centered on the central optical axis and surrounding and adjoining the inner conical surface, a cone angle of the inner conical surface being greater than a cone angle of the outer frustoconical surface, the distal end surface of the optical fiber faces toward the laser light source.

5. The light coupling system of claim 4, wherein the diameter of the fiber core is in a range of 9-100 micrometers.

6. The light coupling system of claim 4, wherein the light emitted from the laser light source has a Gaussian distribution.
